(19) United States
(12) Patent Application Publication
(10) Pub. No.: US 2024/0279965 A1
(43) Pub. Date: Aug. 22, 2024

(54) Temporary Passenger Safety Restraint System and Method

(71) Applicant: David Ashford, Nicholasville, KY (US)

(72) Inventor: David Ashford, Nicholasville, KY (US)

(21) Appl. No.: 18/442,795

(22) Filed: Feb. 15, 2024

Related U.S. Application Data
(60) Provisional application No. 63/446,399, filed on Feb. 17, 2023.

(51) Int. Cl. E05B 75/00

(52) U.S. Cl. CPC E05B 75/00

(57) ABSTRACT

A temporary restraining system, used in a method of restraining an individual, includes a webbing system having (a) a first strap, adapted to overlie a first shoulder of the individual, (b) a second strap, adapted to overlie a second shoulder of the individual, (c) a third strap, adapted to engage a back of the seat, (d) a fourth strap, adapted to encircle the individual and the back of the seat, and (e) an opening, adapted to receive a head of the individual and outlined by the first strap, the second strap, a portion of the third strap and a portion of the fourth strap.

### RELATED APPLICATION

This patent application claims the benefit of U.S. Provisional Patent Application Ser. No. 63/446,399 filed on Feb. 17, 2023, the full disclosure of which is incorporated herein by reference.

### TECHNICAL FIELD

This document relates to a restraint system and related method to safely restrain a disruptive or combative passenger on a public transportation vehicle such as a commercial aircraft.

### BACKGROUND

Currently there is no temporary restraint system specially adapted to be deployed on an aircraft, while in flight, to restrain a disruptive or combative passenger. This system will enable the flight crew, Federal Air Marshal or whomever is designated to quickly and safely secure the disorderly passenger back into their seat but also allow the system to be partially removed in the event of a crash or completely removed in the event of an emergency evacuation.

### SUMMARY

In accordance with the purposes and benefits set forth herein, the temporary restraint system for restraining an individual in a seat, comprises, consists of or consists essentially of a webbing system. That webbing system includes (a) a first strap, adapted to overlie a first shoulder of the individual, (b) a second strap, adapted to overlie a second shoulder of the individual, (c) a third strap, adapted to engage a back of the seat behind the neck of the individual, (d) a fourth strap adapted to encircle the individual and the back of the seat, at or near the waist of the individual, and (e) an opening, adapted to receive the head of the individual. That opening is outlined by the first strap, the second strap, a portion of the third strap and a portion of the fourth strap.

In at least one of the many possible embodiments of the temporary restraint system, the first strap is secured to the third strap at a first point and to the fourth strap at a second point. In addition, the second strap is secured to the third strap at a third point and to the fourth strap at a fourth point.

In at least some embodiments, the temporary restraint system further includes a fifth strap adapted to extend between the legs of the individual under restraint, under the seat, and up the seatback to at least the fourth strap. That fifth strap may be secured to the fourth strap at a fifth point wherein the fifth point is between the second point and the fourth point along the fourth strap.

The temporary restraint system may further include at least one receiver carried on the fifth strap wherein the at least one receiver is adapted to receive and hold the fourth strap behind the back of the seat.

The temporary restraint system may further include a first connector assembly carried by the third strap. The temporary restraint system may further include a second connector assembly carried by the fourth strap. The first connector assembly may include a first latch plate, carried on a first end of the third strap, and a first buckle assembly, carried on a second end of the first strap. The second connector assembly may include a second latch plate, carried on a first end of the fourth strap, and a second buckle assembly, carried on a second end of the fourth strap. The connectors may be standard seat belt buckle assemblies of the type used on commercial aircraft lending familiarity to their use and operation.

In accordance with yet another aspect, the temporary restraint system is useful in a method of restraining an individual in a seat such as found on a commercial airliner. That method comprises, consists of or consists essentially of the steps of: (a) positioning a webbing system over the head of the individual with a first strap of the webbing system overlying a first shoulder of the individual and a second strap of the webbing system overlying a second shoulder of the individual, (b) positioning and securing a third strap of the webbing system around a back of the seat, (c) positioning a fourth strap of the webbing system around a waist of the individual and the back of the seat, (d) positioning a fifth strap of the individual to extend from the fourth strap in front of the individual, between the legs of the individual, under the seat and around to the back of the seat, and (e) securing the fourth strap in place and securing the fifth strap to the fourth strap behind the seat back.

The method may further include positioning the third strap behind the neck of the individual. The method may further include connecting ends of the third strap together and tightening the third strap to secure the third strap in position. The method may further include

connecting ends of the fourth strap together and tightening the fourth strap to secure the fourth strap in position.

In at least some of the many possible embodiments, the method includes connecting the fifth strap to the fourth strap by extending the fourth strap through a receiver carried on the fifth strap. The method may include securing hands of the individual together before positioning the webbing system over the head of the individual. The method may also include inserting the head of the individual through an opening in the webbing system formed between the first, second, third and fourth straps.

In the following description, there are shown and described several embodiments of the temporary restraint system and related method of restraining an individual. As it should be realized, the system and method are capable of other, different embodiments and their several details are capable of modification in various, obvious aspects all without departing from the device and method as set forth and described in the following claims. Accordingly, the drawing and descriptions should be regarded as illustrative in nature and not as restrictive.

### BRIEF DESCRIPTION OF THE DRAWING FIGURES

The accompanying drawing figures incorporated herein by reference and forming a part of the specification, illustrate several aspects of the temporary restraining system and method adapted for restraining an individual such as an unruly, disruptive or combative passenger on a commercial aircraft.

FIG. 1 is a top plan view of the temporary restraint system.

FIGS. 2-6 are various views indicating how the webbing system of the restraint system is used to restrain the individual in a passenger seat of a commercial aircraft. More specifically;

FIG. 2 is a front view illustrating how the webbing system is placed over the head of the individual to be restrained so that the third belt is behind the neck of the individual.

FIG. 3 is a view of the seatback showing how the fifth strap is pulled around the seat bottom and upward across the seatback.

FIG. 4 is a view similar to FIG. 3 but further showing how the fifth strap is secured to the fourth strap as well as the connecting and securing of the third and fourth straps behind the seatback.

FIG. 5 is a view similar to FIGS. 3 and 4 but further showing how the third and fourth traps are tightened down.

FIG. 6 is a front view illustrating the individual fully restrained by the fully deployed temporary restraint system.

### DETAILED DESCRIPTION

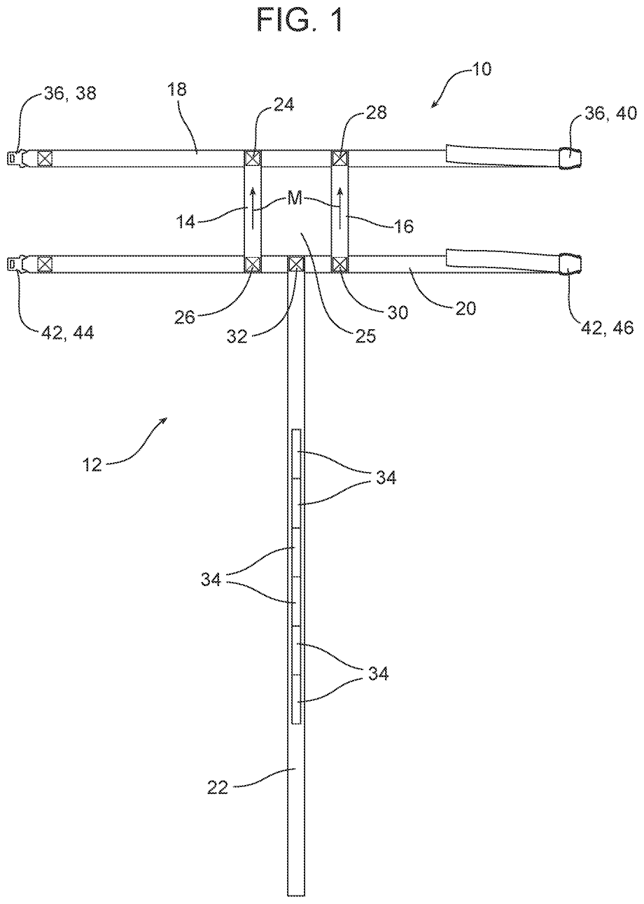

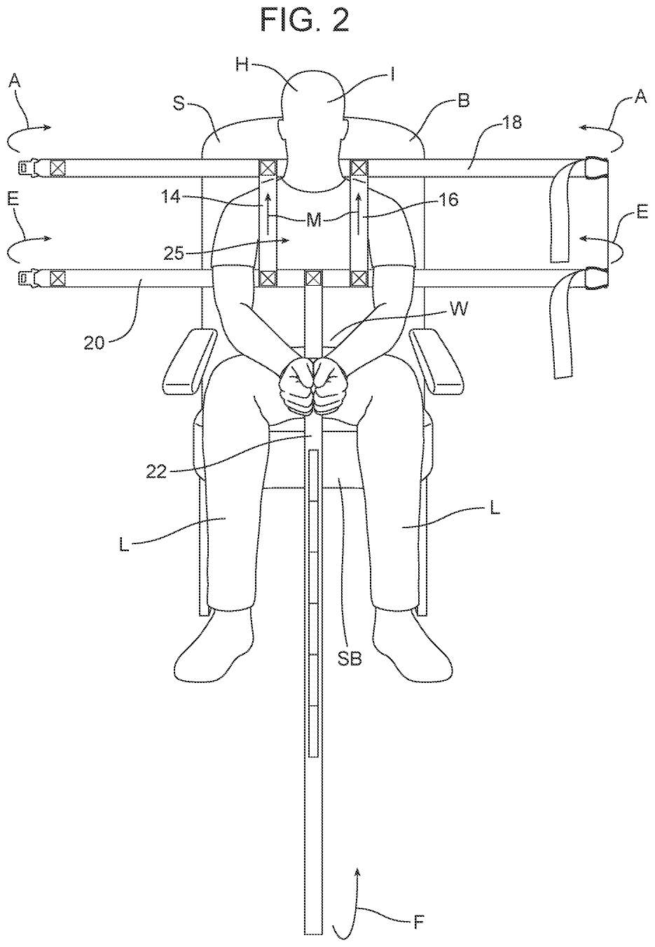

Reference is now made to FIG. 1 which clearly illustrates the temporary restraint system 10. The temporary restraint system 10 comprises a webbing system 12 including a first strap 14, a second strap 16, a third strap 18, a fourth strap 20, a fifth strap 22 and an opening 25. As is shown in FIGS. 2-6 and as will be described in greater detail below, the first strap 14 is adapted to overlie a first shoulder of the individual I to be restrain in the seat S. The second strap 16 is adapted to overlie the second shoulder of the individual I. The third strap 18 is adapted to engage the back B of the seat S. The fourth strap 20 is adapted to encircle the individual I near the lap or waist W and the back B of the seat S. The fifth strap 22 is adapted to extend between the legs L of the individual I and extend around the seat bottom SB, under the seat S up the back B of the seat to the fourth strap 20. The opening 25, defined between the first strap 14, the second strap 16, a portion of the third strap 18 and a portion of the fourth strap 20, is adapted to receive the head H of the individual when the webbing system 12 is put into use to restrain the individual I.

As best shown in FIG. 1, the first strap 14 is secured to the third strap 18 at a first point 24 and to the fourth strap 20 at a second point 26. The second strap 16 is secured to the third strap 18 at a third point 28 and to the fourth strap 20 at a fourth point 30. The fifth strap 22 is secured to the fourth strap 20 at a fifth point 32 wherein the fifth point is between the second point 26 and the fourth point 30.

The various straps 14, 16, 18, 20 and 22 may be made from a high strength webbing material (e.g. nylon webbing) such as is used to make seat belts for automobiles and aircraft. The connection points 24, 26, 28, 30, 32 may be by stitching of the straps together or by connector rings of metal or other high strength material or by any other means known in the art to be useful for connecting straps of webbing material together.

The webbing system 12 is designed to accommodate any size aircraft seat currently found on commercial passenger aircraft. Thus, for example, the first strap 14 and second straps 16, which are spaced about 17.78 cm apart, may have a length of about 45.72 cm. The third strap 18, may have a length of about 127 cm. The fourth strap 20 may have a length of about 213.26 cm. The fifth strap 22 may have a length of about 190.5 cm.

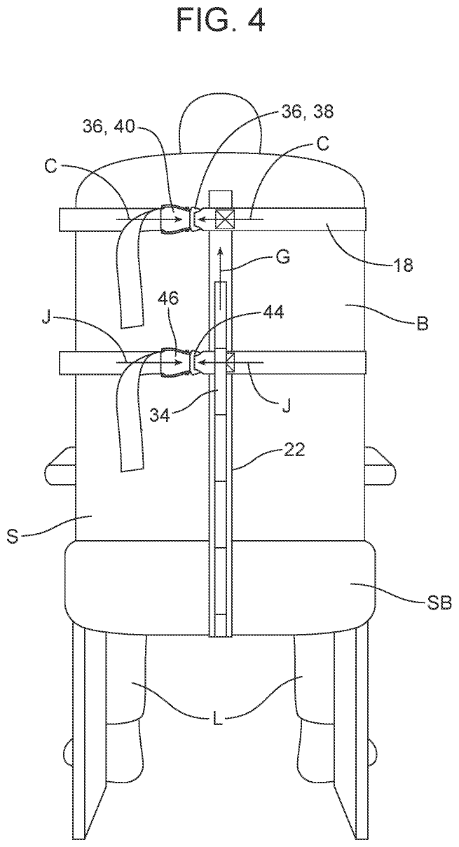

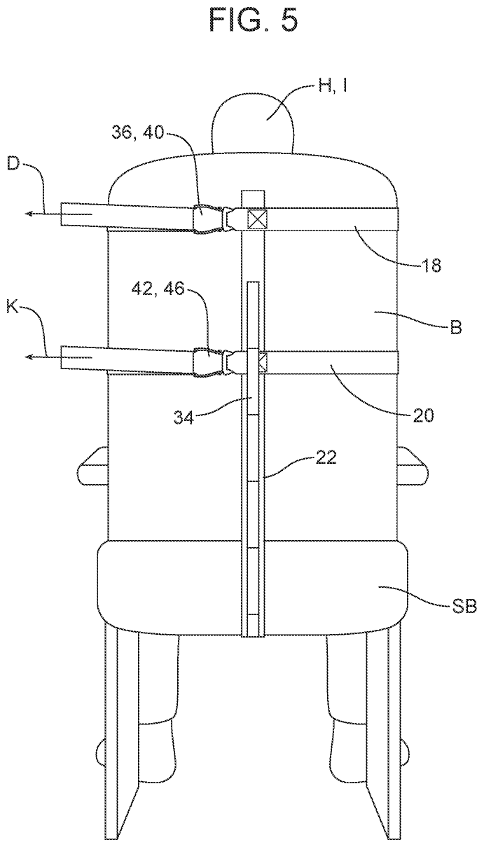

As further shown in FIG. 1, at least one receiver 34 is carried on the fifth strap 22. In fact, the embodiment illustrated in FIG. 1 includes six receivers 34 wherein each such receiver comprises a loop of material stitched at each end thereof to one face of the fifth strap 22. The space between the stitching at the ends of each loop is sufficient to allow the fourth strap 20 to pass through the loop 34. Thus, each receiver 34 is adapted to receive and hold the fourth strap 20 behind the back of the seat in a manner shown in FIGS. 4 and 5 and described in greater detail below.

A first connector assembly 36 is carried by the third strap 18. The first connector assembly 36 includes a first latch plate 38 at a first end of the third strap 18 and a first, cooperating buckle assembly 40 at a second end of the third strap. Similarly, a second connector assembly 42 is carried by the fourth strap 20. The second connector assembly 42 includes a second latch plate 44 at a first end of the fourth strap 20 and a second cooperating buckle assembly 46 at a second end of the fourth strap. The latch plates 38, 44 and cooperating buckle assemblies 40, 46 are of the type used for seat belt systems on commercial aircraft. This allows a user to be immediately familiar with the operation of this feature of the restraint system 10.

Reference is now made to FIGS. 2-6, which clearly illustrate the method of using the restraint system 10 to restrain an unruly individual I in a passenger seat S of a commercial aircraft. After the Air Marshal or flight crew subdues the individual I and cuffs the individual's hands together in front of the individual with a zip-tie or hand cuffs, the individual is returned to the individual's seat S. The temporary restraint system 10 is then removed from its storage bag (not shown). While the Air Marshal or one member of the flight crew controls the individual I, another member deploys the temporary restraint system 10 into place.

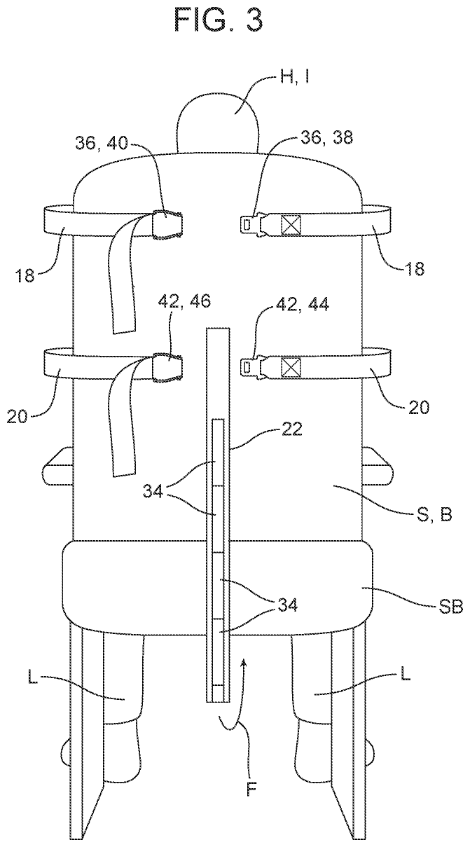

First, the webbing system 12 is positioned over the head of the individual I with the head of the individual sticking through the opening 25, the first strap 14 overlying the first shoulder of the individual, and the second strap 16 overlying the second shoulder of the individual. The third strap 18, is behind the neck of the individual I. See FIG. 2. The third strap 18 is then wrapped around the back B of the seat S. See FIGS. 2 and 3 and note action arrows A in FIG. 2. The latch plate 38 is then secured in the cooperating buckle assembly 40 (See FIG. 4 and note action arrows C) and the distal end of the third strap 18 is pulled through the buckle assembly to take up any slack and tighten the third strap against the seat back B in the same manner as one tightens a seat belt (See FIG. 5 and note action arrow D). As should be appreciated, the first connector assembly 36 is secured behind the seat back B in a position out of reach of the individual I.

Next, the fourth strap 20 is wrapped around the lap or waist W of the individual and the seat back B. See FIGS. 2 and 3 and note action arrows E in FIG. 2. The fifth strap 22 is then dropped down between the legs L of the individual I and fed around under the seat bottom SB and up the seatback B (See FIGS. 2 and 3 and note action arrows F) before securing to the fourth strap 20 behind the seat back B. As the fifth strap 22 is pulled tight (See action arrow G in FIG. 4), the fourth strap 20 is threaded through whichever receiver/loop 34 provides the suggest fit for the fifth strap 22 around the seat bottom SB. The latch plate 44 is then secured in the cooperating buckle assembly 46 of the second connector 42 (See FIG. 4 and note action arrows J) and the distal end of the fourth strap 20 is pulled through the buckle assembly to take up any slack and tighten the fourth strap against the seat back B, once again, in the same manner as one tightens a seat belt (note action arrow K in FIG. 5). While this is done, care is taken to ensure that the individual I is fully and properly seated in the seat S with his or her back against the back of the seat. As should be appreciated, the second connector assembly 42 is also secured behind the seat back B in a position out of reach of the individual I.

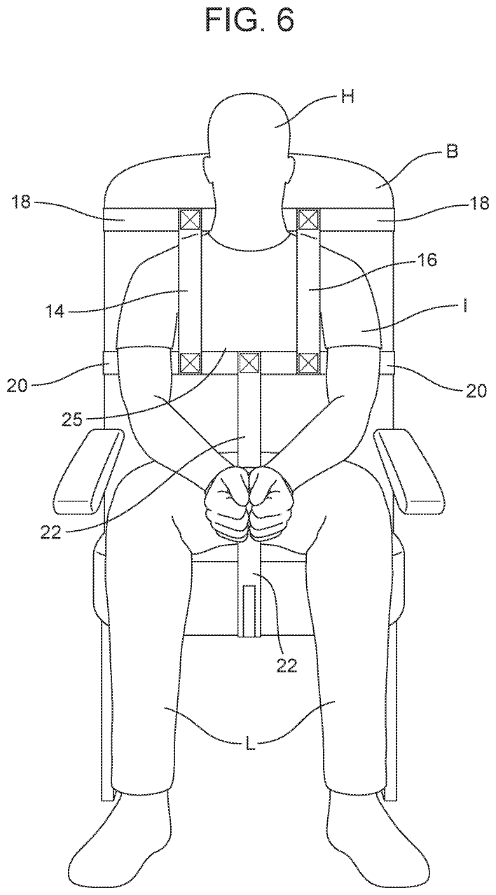

FIG. 6 illustrates the individual I fully restrained by the temporary restraint system. The third, fourth and fifth straps 18, 20 and 22 function together to secure the webbing system 12 to the seat. The first and second straps 14, 16 function in conjunction with the fifth strap 22, extending under the seat bottom SB to prevent the individual from standing up from the seat. The first and second straps 14, 16 and fourth strap 20 function together to prevent the individual from moving forward or side to side. Thus, it should be appreciated that the webbing system 12 of the temporary restraint system 10 is effective to secure the individual I in the seat S for the safety of the individual and the other passengers on the aircraft.

Once the temporary restrain system 10 is in place, the OEM seat belt system of the aircraft should also be secured about the individual I as the temporary restraint system 10 is not meant to provide this crash protection safety function. When the temporary restraint system 10 is in use, the individual I should be continually monitored for breathing, skin color and level of consciousness until the aircraft has landed and the individual can be transferred to the custody of law enforcement.

Numerous benefits and advantages result from use of the temporary restraint system 10 and its associated method. The system 10 and method are easy to use and thereby provide Federal Air Marshals and flight crews with a quick and safe means to secure a disorderly passenger back in their seat S. At the same time, the restraint system 10 allows the Federal Air Marshall or flight crew to partially or fully remove the restraint system 10 as necessary, by simply unbuckling either or both of the buckle assemblies 40, 46 of the first and second connector assemblies 36, 42, in the event of a crash and/or emergency evacuation of the aircraft.

When not in use, the temporary restraint system 10 may be folded into a compact footprint and secured in a bag with a simple nylon webbing having a hook and loop type closure. That bag requires little space and may be stored in a location having ready access as needed by the Air Marshal or flight crew. The straps 14, 16, 18, 20, 22 may include indicia, such as the arrows M shown in FIG. 1, to aid the user when deploying the restraint system 10. Use of the familiar latch plates 38, 44 and cooperating buckle assemblies 40, 46 of standard seat belt systems allow the user to confidently secure the straps 20, 22 in place. Further, such connector assemblies 36, 42 provide a strong connection to secure even the most unruly individual I.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a receiver”, as used herein, may also refer to, and encompass, a plurality of receivers.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to +10% of the stated numerical value.

Although the temporary restraint system and related method of this disclosure have been illustratively described and presented by way of specific exemplary embodiments, and examples thereof, it is evident that many alternatives, modifications, or/and variations, thereof, will be apparent to those skilled in the art. For example, the fifth strap 22 may be secured to the fourth strap 20 behind the seat back B by means of a clip or other fastening means of a type known in the art to be useful for that purpose. In the method, the fifth strap may be secured to the fourth strap behind the seat back B before the fourth strap is secured with the second connector assembly 42. Accordingly, it is intended that all such alternatives, modifications, or/and variations, fall within the spirit of, and are encompassed by, the broad scope of the appended claims.

What is claimed:

1. A temporary restraint system for restraining an individual in a seat, comprising:
a webbing system including (a) a first strap adapted to overlie a first shoulder of the individual, (b) a second strap adapted to overlie a second shoulder of the individual, (c) a third strap adapted to engage a back of the seat, (d) a fourth strap adapted to encircle the individual and the back of the seat and (e) an opening adapted to receive a head of the individual and outlined by the first strap, the second strap, a portion of the third strap and a portion of the fourth strap.

2. The temporary restraint system of claim 1, wherein (a) a first strap is secured to the third strap at a first point and to the fourth strap at a second point and (b) the second strap is secured to the third strap at a third point and to the fourth strap at a fourth point.

3. The temporary restraint system of claim 2, further including a fifth strap adapted to extend under the seat and up the back to at least the fourth strap.

4. The temporary restraint system of claim 3, wherein the fifth strap is secured to the fourth strap at a fifth point wherein the fifth point is between the second point and the fourth point.

5. The temporary restraint system of claim 4, further including at least one receiver carried on the fifth strap wherein the at least one receiver is adapted to receive and hold the fourth strap behind the back of the seat.

6. The temporary restraint system of claim 5, further including a first connector assembly carried by the third strap.

7. The temporary restraint system of claim 6, further including a second connector assembly carried by the fourth strap.

8. The temporary restraint system of claim 7, wherein the first connector assembly includes a first latch plate carried on a first end of the third strap and a first buckle assembly carried on a second end of the first strap.

9. The temporary restraint system of claim 8, wherein the second connector assembly includes a second latch plate carried on a first end of the fourth strap and a second buckle assembly carried on a second end of the fourth strap.

10. A method of restraining an individual in a seat, comprising:
positioning a webbing system over the head of the individual with a first strap of the webbing system overlying a first shoulder of the individual and a second strap of the webbing system overlying a second shoulder of the individual;
positioning and securing a third strap of the webbing system around a back of the seat;
positioning a fourth strap of the webbing system around the individual and the back of the seat; and
positioning a fifth strap to extend from the fourth strap, between the legs of the individual, under the seat and around to the back of the seat;
securing the fifth strap to the fourth strap and then securing the fourth strap in place behind the seat back.

11. The method of claim 10, further including positioning the third strap behind the neck of the individual.

12. The method of claim 11, further including connecting ends of the third strap together and tightening the third strap to secure the third strap in position.

13. The method of claim 12, further including connecting ends of the fourth strap together and tightening the fourth strap to secure the fourth strap in position.

14. The method of claim 13, including connecting the fifth strap to the fourth strap by extending the fourth strap through a receiver carried on the fifth strap.

15. The method of claim 10, further including securing hands of the individual together before positioning the webbing system over the head of the individual.

16. The method of claim 15, further including inserting the head of the individual through an opening in the webbing system formed between the first, second, third and fourth straps.
